(19) United States
(12) Patent Application Publication
(10) Pub. No.: US 2016/0092843 A1
(43) Pub. Date: Mar. 31, 2016

(54) ELECTRONIC DEVICE, METHOD FOR MANAGING SCHEDULE, AND STORAGE MEDIUM

(71) Applicant: Samsung Electronics Co., Ltd., Gyeonggi-do (KR)

(72) Inventors: Da-Hey YOO, Seoul (KR); Yo-Han LEE, Gyeonggi-do (KR); Chi-Hoon LEE, Seoul (KR)

(73) Assignee: Samsung Electronics Co., Ltd.

(21) Appl. No.: 14/867,977

(22) Filed: Sep. 28, 2015

(30) Foreign Application Priority Data
Sep. 26, 2014 (KR) 10-2014-0129402

(51) Int. Cl. G06Q 10/10; G06F 17/27

(52) U.S. Cl. CPC G06Q 10/1093; G06F 17/2705

(57) ABSTRACT

An electronic device, a method of managing a schedule, and a non-transitory computer-readable storage medium are provided. The electronic device includes a processor configured to acquire schedule-related information, acquire parsed data by parsing the acquired schedule-related information, and transmit the parsed data to a plurality of applications, and an output unit configured to output a result of processing the parsed data through the plurality of applications. The method includes acquiring schedule-related information; acquiring parsed data by parsing the acquired schedule-related information; transmitting the parsed data to a plurality of applications; and processing the parsed data through the plurality of applications.

### PRIORITY

This application claims priority under 35 U.S.C. §119(a) to a Korean Patent Application filed on Sep. 26, 2014 in the Korean Intellectual Property Office and assigned Serial No. 10-2014-0129402, the entire disclosure of which is incorporated herein by reference.

### BACKGROUND

1. Field of the Disclosure

The present disclosure relates generally to a method for managing a schedule in an electronic device, and more particularly, to a method for managing a schedule in an electronic device that executes an application.

2. Description of the Related Art

Portable electronic devices capable of executing various applications have recently become popular. An electronic device may store and execute a schedule management application. The electronic device may execute an email application, a text service application, and a telephony application. For example, a user of the electronic device may check schedule information based on contents input to the email application. The user may enter the checked schedule information by executing the schedule management application. In addition, to set an alarm for the schedule information, the user may enter a time corresponding to the schedule information by executing an alarm application separately.

### SUMMARY

An aspect of the present disclosure is to provide an electronic device for, upon receipt of schedule-related information, setting schedule information after parsing the received schedule-related information. The electronic device may control a plurality of applications using the schedule information. Further, the electronic device may manage a schedule based on at least one of user information and external information as well as the received schedule-related information.

In accordance with an aspect of the present disclosure, there is provided an electronic device. The electronic device includes a processor configured to acquire schedule-related information, acquire parsed data by parsing the acquired schedule-related information, and transmit the parsed data to a plurality of applications, and an output unit configured to output a result of processing the parsed data through the plurality of applications.

In accordance with another aspect of the present disclosure, there is provided a method of managing a schedule. The method includes acquiring schedule-related information, acquiring parsed data by parsing the acquired schedule-related information, transmitting the parsed data to a plurality of applications, and processing the parsed data through the plurality of applications.

In accordance with another aspect of the present disclosure, there is provided an electronic device. The electronic device includes a processor configured to acquire parsed data by parsing schedule-related information, acquire at least one of user information about the electronic device and external information, and acquire schedule information based on the parsed data and the at least one of the user information and the external information, and an output unit configured to output the schedule information.

In accordance with another aspect of the present disclosure, there is provided a method of managing a schedule in an electronic device. The method includes acquiring schedule-related information, acquiring parsed data by parsing the schedule-related information, acquiring at least one of user information about the electronic device and external information, acquiring schedule information based on the parsed data and the at least one of the user information and the external information, and outputting the schedule information.

In accordance with another aspect of the present disclosure, there is provided a non-transitory computer-readable storage medium recording a program for performing a method of managing a schedule in an electronic device. The method includes acquiring schedule-related information, acquiring parsed data by parsing the schedule-related information, acquiring at least one of user information about the electronic device and external information, acquiring schedule information based on the parsed data and the at least one of the user information and the external information, and outputting the schedule information.

### BRIEF DESCRIPTION OF THE DRAWINGS

The above and other aspects, features and advantages of certain embodiments of the present disclosure will be more apparent from the following description; taken in conjunction with the accompanying drawings, in which:

FIG. 1 is a block diagram of a network environment including an electronic device according to an embodiment of the present disclosure;

FIG. 2 is a block diagram of a programming module according to an embodiment of the present disclosure;

FIG. 3 is a block diagram of a schedule management module in an electronic device according to an embodiment of the present disclosure;

FIGS. 4A and 4B are flowcharts of methods of managing a schedule according to an embodiment of the present disclosure;

FIGS. 5A to 5E illustrate screen configurations in an electronic device according to an embodiment of the present disclosure;

FIG. 6 is a flowchart of a method of managing a schedule according to an embodiment of the present disclosure;

FIGS. 7A to 7E illustrate screen configurations in an electronic device according to an embodiment of the present disclosure;

FIG. 8 is a flowchart of a method of managing a schedule according to an embodiment of the present disclosure;

FIG. 9A illustrates external information according to an embodiment of the present disclosure;

FIG. 9B is a flowchart of a method of acquiring user information according to an embodiment of the present disclosure;

FIG. 9C illustrates a screen configuration in an electronic device according to an embodiment of the present disclosure;

FIG. 10 is a block diagram of a schedule management system according to an embodiment of the present disclosure;

FIG. 11 is a flowchart of a method of managing a schedule according to an embodiment of the present disclosure;

FIG. 12 is a flowchart of a method of configuring a screen in an electronic device according to an embodiment of the present disclosure;

FIGS. 13A and 13B illustrate screen configurations in an electronic device according to an embodiment of the present disclosure;

FIG. 14 is a flowchart of a method of managing a schedule according to an embodiment of the present disclosure;

FIGS. 15A and 15B illustrate screen configurations in an electronic device according to an embodiment of the present disclosure;

FIG. 16 is a flowchart of a method of managing a schedule according to an embodiment of the present disclosure;

FIG. 17 is a flow diagram of an operation for interacting with a vehicle control device according to an embodiment of the present disclosure;

FIG. 18 illustrates an execution screen of a navigation application in a vehicle control device according to an embodiment of the present disclosure;

FIG. 19 is a flowchart of a method of managing a schedule according to an embodiment of the present disclosure; and

FIG. 20 is a block diagram of an electronic device according to an embodiment of the present disclosure.

### DETAILED DESCRIPTION OF EMBODIMENTS OF THE PRESENT DISCLOSURE

Various embodiments of the present disclosure are described below with reference to the accompanying drawings. However, the scope of the present disclosure is not intended to be limited to an embodiment of the present disclosure and it is to be understood that the present disclosure covers all modifications, equivalents, and/or alternatives falling within the scope of the present disclosure, as defined by the appended claims and their equivalents. In relation to a description of the accompanying drawings, like reference numerals denote the same components.

In the present disclosure, the terms “have,” “may have,” “include,” or “may include” signify the presence of a certain feature (for example, a number, a function, an operation, or a component like a part), not excluding the presence of an additional feature.

In the present disclosure, the expressions “A or B,” “at least one of A or/and B,” and “‘one or more of A or/and B” may cover all possible combinations of enumerated items. For example, the expressions “A or B,” “at least one of A and B,” and “at least one of A or B” may represent all of the cases of (1) inclusion of at least one A, (2) inclusion of at least one B, and (3) at least one A and at least one B.

The terms, as used in an embodiment of the present disclosure, “first” and “second” may modify the names of various components irrespective of sequence and/or importance, but do not limit the components. These expressions may be used to distinguish one component from another component. For example, a first User Equipment (UE) and a second UE may indicate different UEs irrespective of sequence or importance. For example, a first component may be referred to as a second component and vice versa without departing from the scope and spirit of the present disclosure.

When it is indicated that a component (for example, a first component) is “operatively or communicatively coupled with/to” or “connected to” another component (for example, a second component), it should be understood that the component is connected to the other component directly or through any other component (for example, a third component). In contrast, when it is said that a component (for example, a first component) is “directly connected to” or “directly coupled to” another component (for example, a second component), it may be understood that there is no other component (for example, a third component) between the components.

The expression “configured to” as used herein may be replaced with, for example, the expression “suitable for,” “having the capacity to,” “designed to,” “adapted to,” “made to,” or “capable of” under certain circumstances. The expression “configured to” may not necessarily indicate “specifically designed to” in hardware. Instead, the expression “configured to” may indicate that a device may be “capable of” with another device or part. For example, “a processor configured to execute A, B, and C” may indicate a dedicated processor (for example, an embedded processor) for performing the corresponding operations or a general-purpose processor (for example, a Central Processing Unit (CPU) or an application processor) for performing the corresponding operations.

The terms as used in the present disclosure are provided to describe a certain embodiments of the present disclosure, but are not intended to limit the scope of other embodiments of the present disclosure. It is to be understood that singular forms include plural referents unless the context clearly dictates otherwise. The terms and words including technical or scientific terms used in the following description and claims may have the same meanings as generally understood by those skilled in the art. The terms as generally defined in dictionaries may be interpreted as having the same or similar meanings as or to contextual meanings of related technology. Unless otherwise defined, the terms should not be interpreted as ideally or excessively formal meanings. When necessary, even the terms as defined in the present disclosure may not be interpreted as excluding an embodiment of the present disclosure.

According to an embodiment of the present disclosure, an electronic device may be at least one of, for example, a smartphone, a tablet Personal Computer (PC), a mobile phone, a video phone, an e-book reader, a desktop PC, a laptop PC, a netbook computer, a workstation, a server, a Personal Digital Assistant (PDA), a Portable Multimedia Player (PMP), a Moving Picture Experts Group (MPEG-1) audio layer-3 (MP3) player, a mobile medical equipment, a camera, and a wearable device (for example, smart glasses, a Head-Mounted Device (HMD), electronic clothes, an electronic bracelet, an electronic necklace, an electronic appcessory, an electronic tattoo, a smart mirror, or a smart watch).

According to an embodiment of the present disclosure, an electronic device may be a smart home appliance. For example, a smart home appliance may be at least one of a Television (TV), a Digital Versatile Disk (DVD) player, an audio player, a refrigerator, an air conditioner, a vacuum cleaner, an oven, a microwave oven, a washer, an air purifier, a set-top box, a home automation control panel, a security control panel, a TV box (for example, Samsung HomeSync™, Apple TV®, Google TV™, or the like), a game console (for example, Xbox™, PlayStation®, or the like), an electronic dictionary, an electronic key, a camcorder, and an electronic picture frame.

According to an embodiment of the present disclosure, an electronic device may be at least one of a medical device (for example, a portable medical meter such as a blood glucose meter, a heart rate meter, a blood pressure meter, or a temperature meter, a Magnetic Resonance Angiography (MRA) device, a Magnetic Resonance Imaging (MRI) device, a Computed Tomography (CT) device, an imaging device, an ultrasonic device, or the like), a navigation device, a Global Positioning System (GPS) receiver, an Event Data Recorder (EDR), a Flight Data Recorder (FDR), an automotive infotainment device, a naval electronic device (for example, a naval navigation device, a gyrocompass, or the like), an avionic electronic device, a security device, an in-vehicle head unit, an industrial or consumer robot, an Automated Teller Machine (ATM) in a financial facility, a Point Of Sale (POS) device in a shop, an Internet of Things (IoT) device (for example, a light bulb, various sensors, an electricity or gas meter, a sprinkler, a fire alarm, a thermostat, a street lamp, a toaster, sporting goods, a hot water tank, a heater, or a boiler), and the like.

According to an embodiment of the present disclosure, an electronic device may be at least one of furniture, a part of a building/structure, an electronic board, an electronic signature receiving device, a projector, and various measuring devices (for example, water, electricity, gas or electro-magnetic wave measuring devices). An electronic device according to an embodiment of the present disclosure may be one or a combination of two or more of the foregoing devices. Also, an electronic device according to an embodiment of the present disclosure may be a flexible device. In addition, it will be apparent to one having ordinary skill in the art that an electronic device according to the present disclosure is not limited to the foregoing devices and covers an electronic device that will be developed.

With reference to the accompanying drawings, an electronic device according to an embodiment of the present disclosure is described below. In the present disclosure, the term “user” may refer to a person or a device (for example, an artificial intelligence electronic device) that uses an electronic device.

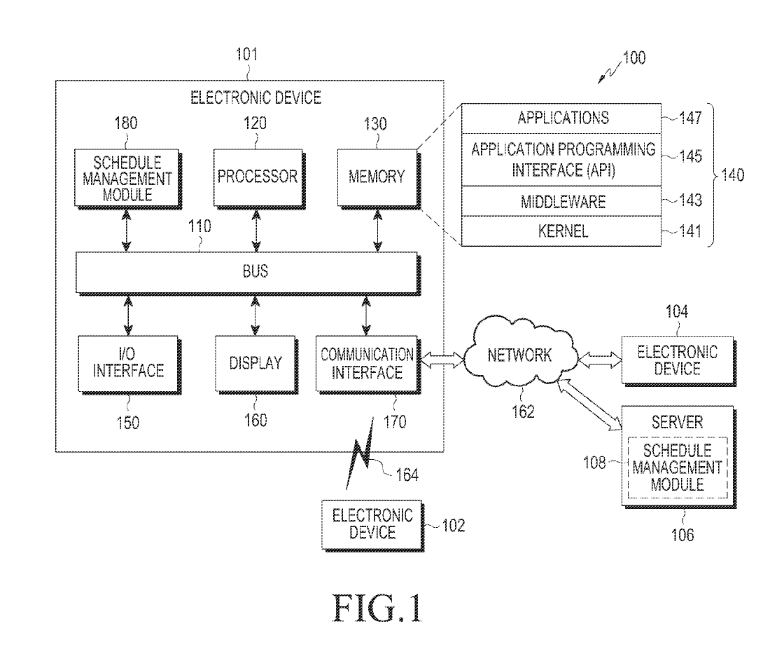

FIG. 1 is a block diagram of a network environment 100 including an electronic device 101 according to an embodiment of the present disclosure.

Referring to FIG. 1, the electronic device 101 in the network environment 100 may include a bus 110, a processor 120, a memory 130, an Input/Output (I/O) interface 150, a display 160, a communication interface 170, and a schedule management module 180. In an embodiment of the present disclosure, at least one of the components may be omitted from, or a component may be added to, the electronic device 101.

The bus 110 may include a circuit that interconnects, for example, the foregoing components 110 to 180 and allows communication (for example, control messages and/or data) between the foregoing components 110 to 180.

The processor 120 may include one or more of a Central Processing Unit (CPU), an Application Processor (AP), and a Communication Processor (CP). The processor 120 may, for example, perform a computation or process data related to control and/or communication of at least one other component of the electronic device 101.

The memory 130 may include a volatile memory and/or a non-volatile memory. The memory 130 may, for example, store instructions or data related to at least one other component. For example, the memory 130 may store software and/or programs 140. The programs 140 may include, for example, a kernel 141, middleware 143, an Application Programming Interface (API) 145, and/or application programs (or applications) 147. At least a part of the kernel 141, the middleware 143, or the API 145 may be referred to as an Operating System (OS).

The kernel 141 may control or manage system resources (for example, the bus 110, the processor 120, or the memory 130) that are used in executing operations or functions implemented in other programs such as the middleware 143, the API 145, or the application programs 147. Also, the kernel 141 may provide an interface for allowing the middleware 143, the API 145, or the application programs 147 to access and control or manage individual components of the electronic device 101.

The middleware 143 may serve as a medium through which the kernel 141 may communicate with the API 145 or the application programs 147 to transmit and receive data. Also, the middleware 143 may perform control operations (for example, scheduling or load balancing) in regard to work requests by at least one of the application programs 147 by, for example, assigning priorities for using system resources (e.g., the bus 110, the processor 120, or the memory 130) of the electronic device 101 to the at least one application program 147.

The API 145 is an interface that may control functions that the application programs 147 provide at the kernel 141 or the middleware 143. For example, the API 145 may include at least one interface or function (for example, a command) for file control, window control, video processing, or text control.

In the present disclosure, an application may be referred to as an application program.

The I/O interface 150 may act as an interface that provides a command or data received from a user or an external device to the other component(s). Further, the I/O interface 150 may output a command or data received from the other component(s) to a user or an external device.

The display 160 may include, for example, a Liquid Crystal Display (LCD), a Light Emitting Diode (LED) display, an Organic LED (OLED) display, a Microelectromechanical Systems (MEMS) display, or an electronic paper display. The display 160 may display, for example, various types of content (for example, text, an image, a video, an icon, or a symbol) to a user. The display 160 may include a touch screen and receive, for example, a touch input, a gesture input, a proximity input, or a hovering input through an electronic pen or a part of a user's body.

The communication interface 170 may establish communication between the electronic device 101 and an external device (for example, a first electronic device 102, a second electronic device 104, or a server 106). For example, the communication interface 170 may be connected to a network 162 by wireless or wired communication and communicate with the second electronic device 104 or the server 106 over the network 162.

The wireless communication may be conducted using, for example, at least one of Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), or Global System for Mobile communications (GSM)), as a cellular communication protocol. The wired communication may be conducted in conformance to, for example, at least one of a Universal Serial Bus (USB), a High Definition Multimedia Interface (HDMI), a Recommended Standard 232 (RS-232), or a Plain Old Telephone Service (POTS). The network 162 may be a communication network, for example, at least one of a computer network (for example, a Local Area Network (LAN) or a Wide Area Network (WAN)), the Internet, and a telephone network.

Each of the first and second external electronic devices 102 and 104 may be of the same type as, or a different type from, the electronic device 101. According to an embodiment of the present disclosure, the server 106 may include a group of one or more servers. According to an embodiment of the present disclosure, all or a part of the operations performed in the electronic device 101 may be performed in one or more of the electronic devices 102 and 104 and the server 106. According to an embodiment of the present disclosure, if the electronic device 101 is to perform a function or a service automatically or upon request, the electronic device 101 may request that at least a part of the functions related to the function or the service be performed by the electronic device 102 or 104 or the server 106, instead of performing the function or the service by the electronic device 101 autonomously, or additionally. The electronic device 102 or 104 or the server 106 may execute the requested function or an additional function and provide a result of the function execution to the electronic device 101. The electronic device 101 may provide the requested function or service using the received result or by additionally processing the received result. For this purpose, for example, cloud computing, distributed computing, or client-server computing may be used.

According to an embodiment of the present disclosure, the schedule management module 180 may support an operation of the electronic device 101 by performing at least one of the operations (or functions) implemented in the electronic device 101. For example, the server 106 may include a schedule management module 108 capable of supporting the schedule management module 180 implemented in the electronic device 101. For example, the schedule management module 108 may include at least one of the components of the schedule management module 180 and perform (or take over) at least one of the operations performed by the schedule management module 180.

The schedule management module 180 may process at least a part of information acquired from other components (for example, the processor 120, the memory 130, the I/O interface 150, and the communication interface 170) and use the at least partial information in various manners. For example, the schedule management module 180 may control at least a part of the functions of the electronic device 101 so that the electronic device 101 may interact with the electronic device 102 or 104 or the server 106. The schedule management module 180 may be integrated into the processor 120 or the communication interface 170. According to an embodiment of the present disclosure, at least one component of the schedule management module 180 may be incorporated into the server 106 (for example, the schedule management module 108) and the server 106 may support at least one operation performed by the schedule management module 180.

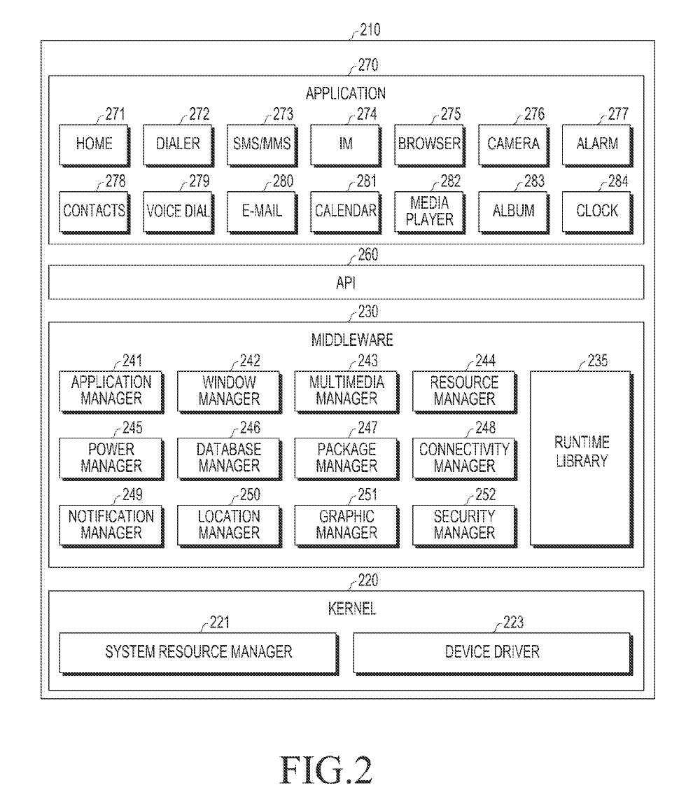

FIG. 2 is a block diagram of a programming module 210 according to an embodiment of the present disclosure. According to an embodiment of the present disclosure, the programming module 210 (for example, a program 140 in FIG. 1) may include an OS that controls resources related to an electronic device (for example, the electronic device 101) and/or various applications executed on the OS (for example, the application programs 147). For example, the OS may be Android, iOS, Windows®, Symbian, Tizen™, Bada, or the like.

Referring to FIG. 2, the programming module 210 may include a kernel 220, middleware 230, an Application Programming Interface (API) 260, and/or an application 270. At least a part of the programming module 210 may be preloaded on an electronic device or downloaded from a server (for example, the server 106).

The kernel 220 (for example, the kernel 141 illustrated in FIG. 1) may include, for example, a system resource manager 221 and/or a device driver 223. The system resource manager 221 may control, allocate, or deallocate system resources. According to an embodiment of the present disclosure, the system resource manager 221 may include a processor manager, a memory manager, or a file system manager. The device driver 223 may include, for example, a display driver, a camera driver, a Bluetooth (BT) driver, a shared memory driver, a USB driver, a keypad driver, a Wireless Fidelity (WiFi) driver, an audio driver, or an Inter-Process Communication (IPC) driver.

The middleware 230 may, for example, provide a function required commonly for the application 270 or provide various functionalities to the application 270 through the API 260 so that the application 270 may efficiently use limited system resources available within the electronic device. According to an embodiment of the present disclosure, the middleware 230 may include at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, or a security manager 252.

The runtime library 235 may include, for example, a library module that a complier uses to add a new function in a programming language during execution of an application 270. The runtime library 235 may perform input/output management, memory management, a function related to an arithmetic function, or the like.

The application manager 241 may manage, for example, the life cycle of at least one of the application 270. The window manager 242 may manage Graphical User Interface (GUI) resources used for a screen. The multimedia manager 243 may determine formats required to play back various media files and may encode or decode a media file using a COder/DECoder (CODEC) suitable for the format of the media file. The resource manager 244 may manage resources such as source code of at least one of the application 270, a memory, or storage space.

The power manager 245 may, for example, manage a battery or a power source by operating in conjunction with a Basic Input/Output System (BIOS) and may provide power information required for an operation. The database manager 246 may manage a database for at least one of the application 270 so that the database may be generated, searched, or modified. The package manager 247 may manage installation or update of an application distributed as a package file.

The connectivity manager 248 may manage, for example, wireless connectivity of WiFi, Bluetooth, or the like. The notification manager 249 may indicate or notify an event such as message arrival, a schedule, a proximity alarm, or the like in a manner that does not bother a user. The location manager 250 may mange position information about the electronic device. The graphic manager 251 may manage graphical effects to be provided to the user or related user interfaces. The security manager 252 may provide an overall security function required for system security, user authentication, and the like. In an embodiment of the present disclosure, if the electronic device 101 has a telephony function, the middleware 230 may further include a telephony manager to manage a voice or video call function of the electronic device 101.

A new middleware module may be created and used by combining various functions of the above-described component modules in the middleware 230. The middleware 230 may provide a customized module for each OS type in order to provide differentiated functions. In addition, the middleware 230 may dynamically delete a part of the existing components or add a new component.

The API 260 (for example, the API 145 in FIG. 1) is, for example, a set of API programming functions, which may be configured differently according to an OS. For example, in the case of Android or iOS, one API set may be provided per platform, whereas in the case of Tizen™, two or more API sets may be provided per platform.

The application 270 may include, for example, one or more applications capable of providing functions such as a home application 271, a dialer application 272, a Short Message Service/Multimedia Messaging Service (SMS/MMS) application 273, an Instant Message (IM) application 274, a browser application 275, a camera application 276, an alarm application 277, a contacts application 278, a voice dial application 279, an email application 280, a calendar application 281, a media player application 282, an album application 283, a clock application 284, and a health care application (for example, an application for measuring an amount of exercise or a glucose level), or providing environmental information (for example, information about air pressure, humidity, or temperature).

According to an embodiment of the present disclosure, the application 270 may include an application (or “information exchange application”) supporting information exchange between the electronic device 101 and an external electronic device 102 or 104. The information exchange application may include, for example, a notification relay application for transmitting certain information to the external electronic device 102 or 104 or a device management application for managing the external electronic device 102 or 104.

For example, the notification relay application may include a function of transmitting notification information generated from another application (for example, an SMS/MMS application 273, an email application 280, a health care application, or an environmental information application) to the external electronic device 102 or 104. Also, the notification relay application may, for example, receive notification information from the external electronic device 102 or 104 and transmit the received notification information to a user. The device management application may, for example, manage (for example, install, delete, or update) at least a part of the functions of the external electronic device 102 or 104 communicating with the electronic device (for example, turn-on/turn-off of the external electronic device 102 or 104 (or a part of its components) or control of the brightness (or resolution) of the display), an application executed in the external electronic device, or a service (for example, a call service or a message service) provided by the external electronic device 102 or 104.

According to an embodiment of the present disclosure, the applications 270 may include an application (for example, a health care application) designated according to a property (for example, the type of the electronic device as a property of the electronic device is a mobile medical device) of the external electronic device 102 or 104. According to an embodiment of the present disclosure, the application 270 may include an application received from an external electronic device 102 or 104. The application 270 may include a preloaded application or a third party application downloadable from a server. The names of components of the programming module 210 according to an embodiment of the present disclosure may vary according to the type of an OS.

According to an embodiment of the present disclosure, at least a part of the programming module 210 may be implemented in software, firmware, hardware, or a combination of at least two of them. At least a part of the programming module 210 may be implemented (for example, executed) by a processor (for example, the AP 210). At least a part of the programming module 210 may include, for example, a module, a program, a routine, a set of instructions, or a process to execute one or more functions.

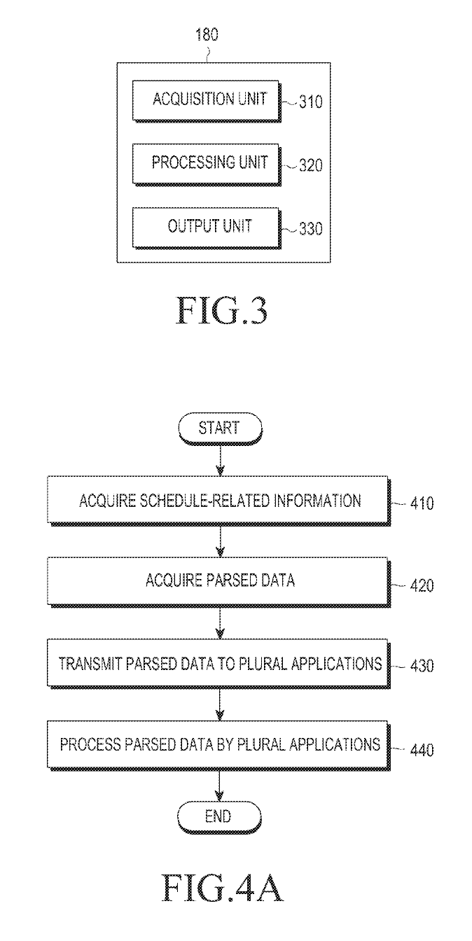

FIG. 3 is a block diagram of the schedule management module 180 in an electronic device 101 according to an embodiment of the present disclosure.

Referring to FIG. 3, the schedule management module 180 may include an acquisition unit 310, a processing unit 320, and an output unit 330. The schedule management module 180 may be configured separately from a processor (for example, the processor 120 in FIG. 1) or may be incorporated wholly or partially in the processor.

According to an embodiment of the present disclosure, the acquisition unit 310 may acquire schedule-related information and acquire parsed data by parsing the acquired schedule-related information. The processing unit 320 may provide the parsed data to a plurality of applications and transmit a result of processing the parsed data by the applications to the output unit 330. The output unit 330 may display, for example, the processing result, as the display 160 of the electronic device 101. Alternatively, the output unit 330 such as an audio player may output an alarm.

According to an embodiment of the present disclosure, the processing unit 320 may determine properties of the parsed data and determine the plurality of applications based on the determined properties of the parsed data.

According to an embodiment of the present disclosure, the processing unit 320 may apply a change in schedule information caused by a first application, acquired from the acquisition unit 310, to the plurality of applications. The output unit 330 may output a result of applying the schedule information change.

According to an embodiment of the present disclosure, the processing unit 320 may control the display of a guide including the acquired parsed data and transmit the parsed data to the plurality of applications based on a schedule information generation command acquired through the guide.

According to an embodiment of the present disclosure, the processing unit 320 may determine whether schedule information corresponding to the parsed data overlaps with other pre-stored schedule information. If the schedule information corresponding to the parsed data overlaps with the other pre-stored schedule information, the processing unit 320 may control the output unit 330 to display a guide that recommends a new schedule.

According to an embodiment of the present disclosure, the acquisition unit 310 may acquire parsed data by parsing schedule-related information, acquire at least one of user information about the electronic device and external information, and acquire schedule information based on the parsed data and at least one of the user information and the external information. The output unit 330 may output the schedule information.

According to an embodiment of the present disclosure, the processing unit 320 may determine a property of the schedule information and determine a corresponding application based on the property of the schedule information.

According to an embodiment of the present disclosure, the processing unit 320 may modify the schedule information corresponding to the parsed data based on at least one of the user information and the external information. The parsed data may include at least one of a scheduled time, a scheduled place, and a schedule name. The user information may include information related to a use pattern of the electronic device. The external information may include at least one of traffic state information and expected time information related to at least one of the scheduled time and place.

According to an embodiment of the present disclosure, the processing unit 320 may determine whether the schedule information is viable based on at least one of the user information and the external information. If the schedule information is not viable, the processing unit 320 may control the output unit 330 to output a corresponding action.

According to an embodiment of the present disclosure, the processing unit 320 may control the output unit 330 to display a guide including the schedule information. The processing unit 320 may generate the schedule information based on a schedule information generation command acquired through the guide.

According to an embodiment of the present disclosure, the processing unit 320 may determine whether the schedule information overlaps with other pre-stored schedule information. If the schedule information overlaps with the other pre-stored schedule information, the processing unit 320 may control the output unit 330 to display a guide that recommends a new schedule.

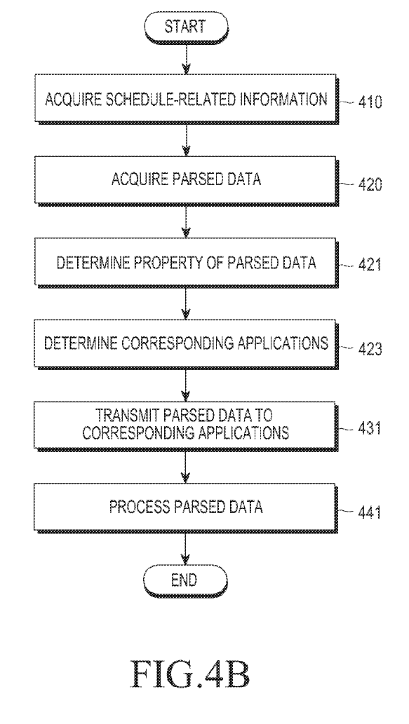

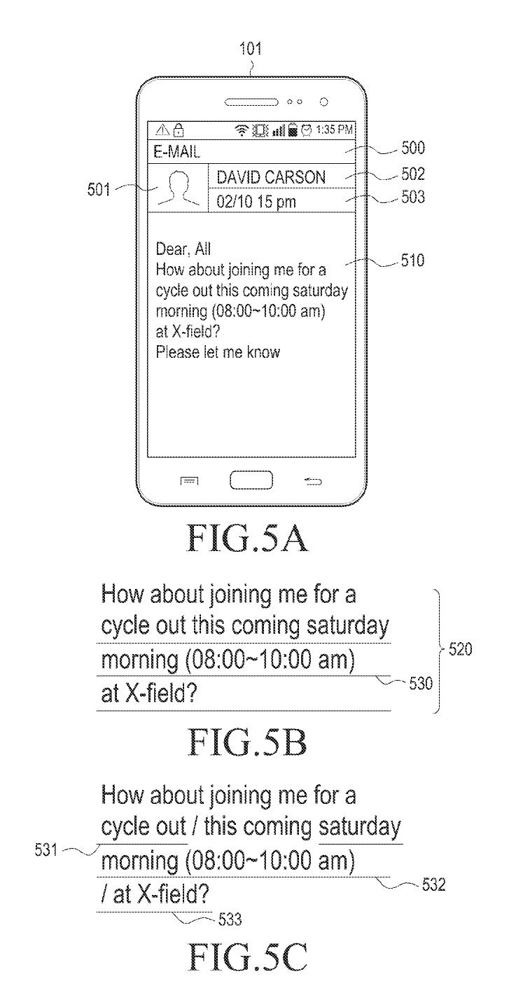

FIGS. 4A and 4B are flowcharts of methods of managing a schedule according to an embodiment of the present disclosure. The schedule management methods illustrated in FIGS. 4A and 4B are described below in detail with reference to FIGS. 5A to 5E.

Referring to FIG. 4A, the electronic device 101 may acquire schedule-related information in step 410. The schedule-related information may refer to information related to a schedule acquired from a scheduling application. The scheduling application is an application from which schedule-related information may be acquired, including, for example, an email application, a text message service application, a messenger application, and a telephony application. The electronic device 101 may acquire the schedule-related information through the scheduling application. According to an embodiment of the present disclosure, if the scheduling application is an email application, the schedule-related information may be an email including at least one of a scheduled time, a scheduled place, and a schedule name.

For example, the electronic device 101 may execute an email application 500, as illustrated in FIG. 5A. In an embodiment of the present disclosure illustrated in FIG. 5, the scheduling application may be the email application 500. The electronic device 101 may display an execution screen of the email application 500 as illustrated in FIG. 5A. According to an embodiment of the present disclosure, the execution screen of the email application 500 may include at least one of a photo 501 of a sender, a name of the sender 502, a reception time 503, and received contents 510. It will be readily understood by those skilled in the art that the configuration of the execution screen of the email application 500 illustrated in FIG. 5A is merely an example, and the present disclosure is not limited thereto. The contents displayed on the execution screen of the email application 500 may be schedule-related information.

Referring to FIG. 4A, the electronic device 101 may acquire parsed data by parsing the schedule-related information in step 420.

For example, as illustrated in FIG. 5B, the electronic device 101 may acquire parsed data 520 including at least one of a schedule name, a scheduled time, and a scheduled place from the received contents 510. The electronic device 101 may parse the parsed data 520 acquired from the schedule information into a schedule name 531, a scheduled time 532, and a scheduled place 533, as illustrated in FIG. 5C. In the embodiment of the present disclosure illustrated in FIG. 5C, the electronic device 101 may acquire “cycle out” as the schedule name 531, “this coming Saturday morning (08:00˜10:00 am)” as the scheduled time 532, and “X-field” as the scheduled place 533, as the result of the parsing. The electronic device 101 may determine the schedule name 531 based on, for example, an email title or parsed contents of a body of text. The electronic device 101 may perform parsing based on preset event-related terms (for example, meeting, party, agenda, join, and the like). The electronic device 101 may determine the first mentioned time in the parsed data to be the scheduled time 532. If the electronic device 101 acquires a plurality of time-related parsed data, the electronic device 101 may determine the scheduled time 532 based on a selection from among a plurality of parsed data candidates. The electronic device 101 may determine the scheduled time 532 based on a preset future or past tense (for example, “tomorrow,” “afternoon,” “next week,” “previous week,” “yesterday,” and the like). The electronic device 101 may determine the scheduled place 533 based on pre-stored prepositions put after location names or places. The above-described parsing method is merely an example, and thus those skilled in the art will readily understand that the present disclosure is not limited by the parsing method.

Referring to FIG. 4A, the electronic device 101 may transmit the parsed data to a plurality of applications in step 431.

As illustrated in FIGS. 5D and 5E, for example, the electronic device 101 may transmit the parsed data to a schedule management application 540 and an alarm application 550, respectively. The electronic device 101 may transmit the schedule name 531, the scheduled time 532, and the scheduled place 533 to the schedule management application 540 and the alarm application 550.

Referring to FIG. 4A, the electronic device 101 may process the parsed data through the plurality of applications in step 441.

For example, the electronic device 101 may execute the schedule management application 540, as illustrated in FIG. 5D. According to an embodiment of the present disclosure, an execution screen of the schedule management application 540 may include a schedule 541 for Fri. 13 February and a schedule 542 for Fri. 14 February. As described before, the electronic device 101 may transmit the parsed data to the schedule management application 540. For example, the electronic device 101 may transmit the schedule name 531, the scheduled time 532, and the scheduled place 533 to the schedule management application 540. The schedule management application 540 may add a new schedule 543, “Cycle out” for 08:00, Sat. 14 February That is, the electronic device 101 may process the parsed data by adding the new schedule 543.

The electronic device 101 may add the new schedule 543 by executing the schedule management application 540. The electronic device 101 may or may not display the execution screen of the schedule management application 540. The electronic device 101 may transmit an add command for the new schedule 543, along with the parsed data to the schedule management application 540. Alternatively, according to an embodiment of the present disclosure, the schedule management application 540 may be pre-configured to add the parsed data as the new schedule 543, upon receipt of the parsed data. For example, the parsed data may be in a preset format and the schedule management application 540 may identify and process the parsed data according to the format. Alternatively, the electronic device 101 may configure a schedule management agent at a middleware layer. According to an embodiment of the present disclosure, the schedule management agent may transmit or receive data to and from an application executed at an application layer. The schedule management agent may receive schedule-related information from the email application 500. The schedule management agent may acquire parsed data by parsing the schedule-related information. The schedule management agent may transmit the parsed data to the schedule management application 540. The schedule management application 540 may be pre-configured to add the data received from the schedule management agent as the new schedule 543.

For example, as illustrated in FIG. 5E, the electronic device 101 may execute the alarm application 550. According to an embodiment of the present disclosure, an execution screen of the alarm application 550 may include a new alarm 551 set for Sat. 14 February 552. More specifically, the electronic device 101 may transmit the schedule name 531, the scheduled time 532, and the scheduled place 533 to the alarm application 550. The alarm application 550 may add the new alarm 551 for 07:00, Sat. 14 February 552. That is, the electronic device 101 may process the parsed data by adding the new alarm 551.

The electronic device 101 may add the new alarm 551 by executing the alarm application 550. The electronic device 101 may or may not display the execution screen of the alarm application 550. The electronic device 101 may transmit an add command for the new alarm 551, along with the parsed data to the alarm application 550. Alternatively, according to an embodiment of the present disclosure, the alarm application 550 may be pre-configured to add the parsed data as the new alarm 551, upon receipt of the parsed data. For example, the parsed data may be in a preset format and the alarm application 550 may identify and process the parsed data according to the format. Alternatively, the schedule management agent may transmit the parsed data to the alarm application 550. The alarm application 550 may be pre-configured to add the data received from the schedule management agent as the new alarm 551.

In addition, the electronic device 101 may modify the scheduled time 552 from 08:00 to 07:00 and add the new alarm 551 for the modified scheduled time 552, instead of applying the scheduled time 532, that is, 08:00 to the alarm application 550. That is, the electronic device 101 may modify the parsed data and apply the modified parsed data to the application, instead of applying the parsed data to the application, as is. For example, the electronic device 101 may modify the parsed data in consideration of a time taken by a user to get ready and a traffic state of a scheduled day as well as the scheduled time 532 of the parsed data. This is described below in greater detail.

As described above, the electronic device 101 may parse schedule-related information from a scheduling application, transmit the parsed data to a plurality of applications, and process the parsed data through each of the applications.

FIG. 4B is a flowchart of a method of managing a schedule according to an embodiment of the present disclosure.

Steps 410 and 420 have been described above in detail with reference to FIG. 4A and thus are not described further.

In step 421, the electronic device 101 may determine a property of parsed data. For example, the electronic device 101 may determine the property of the parsed data as inclusion of the schedule name 531, the scheduled time 532, and the scheduled place 533 in the parsed data.

In step 423, the electronic device 101 may determine corresponding applications based on the determined property. For example, the electronic device 101 may determine the corresponding applications to be the schedule management application 540 and the alarm application 550 based on the inclusion of the schedule name 531, the scheduled time 532, and the scheduled place 533 in the parsed data.

In step 431, the electronic device 101 may provide the parsed data to the corresponding applications. The corresponding applications may process the parsed data in step 441.

As described above, it is merely an example to configure the electronic device 101 so as to determine a corresponding application based on a property of parsed data. In an embodiment of the present disclosure, the electronic device 101 may preset an application that is to process parsed data.

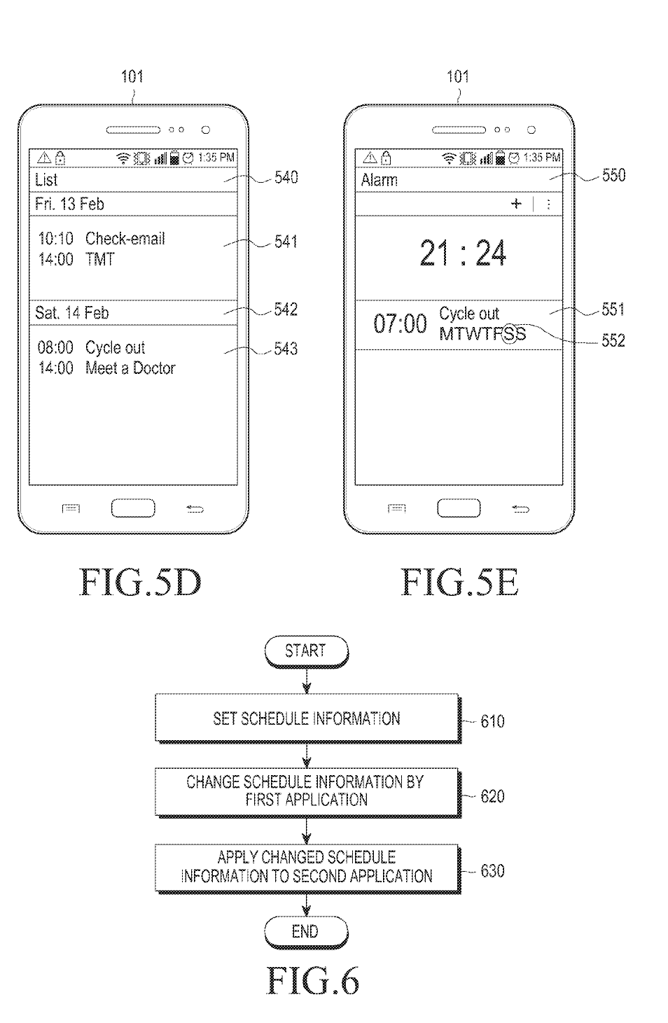

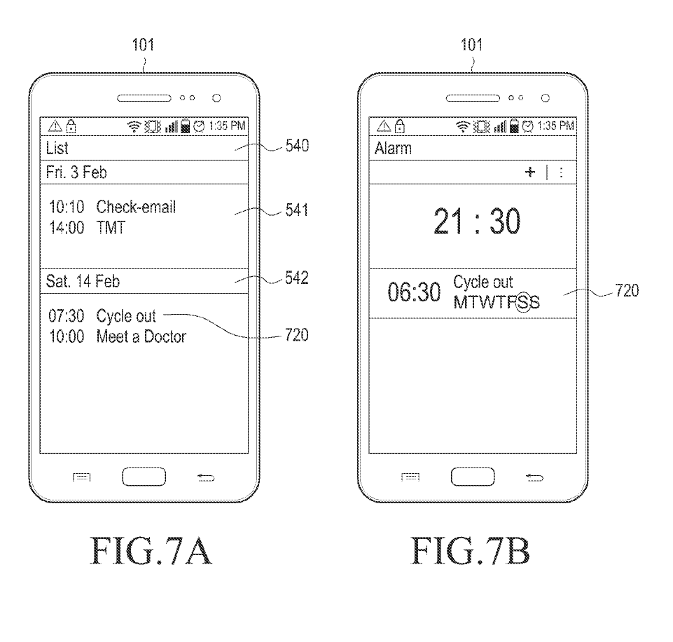

FIG. 6 is a flowchart of a method of managing a schedule according to an embodiment of the present disclosure. The embodiment of the present disclosure illustrated in FIG. 6 is described in detail below with reference to FIGS. 7A to 7E. FIGS. 7A to 7E illustrate screen configurations of the electronic device 101 according to an embodiment of the present disclosure.

Referring to FIG. 6, the electronic device 101 may set schedule information in step 610. The schedule information may refer to information set by a scheduling application. For example, as illustrated in FIG. 5D, the new schedule 543 added to the schedule management application 540 or the new alarm 551 added to the alarm application 550 may be referred to as schedule information. The electronic device 101 may set schedule information, for example, through each of a plurality of applications.

In step 620, the schedule information may be changed by a first application executed in the electronic device 101. The first application may be one of schedule execution applications or one of scheduling applications. For example, the first application may be the email application 500 as illustrated in FIG. 7C.

Referring to FIG. 7C, the email application 500 may receive a new email from “DAVID CARSON” and display the new email. The email application 500 may display new received email contents 730. The new received email contents 730 may include time change information 731 indicating that the starting time of the “cycle out” schedule has been changed from 08:00 to 07:30.

The electronic device 101 may change the starting time of the “cycle out” schedule from 08:00 to 07:30.

In step 630, the electronic device 101 may apply the changed schedule information to a second application. The second application may be different from the first application. A plurality of second applications may exist.

For example, as illustrated in FIG. 7A, the electronic device 101 may apply the changed schedule information to the schedule management application 540 as the second application. In FIG. 7A, an execution screen of the schedule management application 540 may include changed schedule information 720 indicating 07:30 for the “Cycle out” schedule on Sat. 14 February 542, which has been changed from 08:00.

Alternatively, the electronic device 101 may apply the changed schedule information to the alarm application 550 as the second application, as illustrated in FIG. 7B. In FIG. 7B, an execution screen of the alarm application 550 may include changed schedule information 720 indicating an alarm set for 06:30 on Sat. 14 February, which has been changed from 07:00. The electronic device 101 may advance the alarm time by 30 minutes because the schedule has been advanced by 30 minutes.

FIGS. 7D and 7E illustrate screen configurations in an electronic device according to an embodiment of the present disclosure. For example, FIGS. 7D and 7E illustrate screen configurations of an electronic device in the case where schedule information which has been set is deleted.

For example, the electronic device 101 may receive a new email indicating that the “cycle out” schedule has been canceled. Referring to FIG. 7D, the electronic device 101 may display an application screen 740 without information about the “cycle out” schedule set for 08:00. Alternatively, the electronic device 101 may display a “cycle out” schedule 750 in FIG. 7E for which an alarm is changed to 09:30, in view of a “Meet a Doctor” schedule.

The embodiment illustrated in FIGS. 7A to 7E in which the electronic device 101 acquires a schedule change through the email application 500 is merely an example, and the present disclosure is not limited thereto. In an embodiment of the present disclosure, the electronic device 101 may acquire a schedule change through the schedule management application 540 or the alarm application 550. For example, a user may manipulate the electronic device 101 so that the electronic device 101 may execute the schedule management application 540 and change the starting time of the “cycle out” schedule from 08:00 to 07:30 or delete the starting time of the “cycle out” schedule. In the above case, the alarm application 550 may set the changed schedule information 720 as illustrated in FIG. 7B. That is, the electronic device 101 may acquire a schedule change from a schedule execution application as well as from a scheduling application. Further, the electronic device 101 may apply the acquired schedule change to the schedule execution application as well as to the scheduling application.

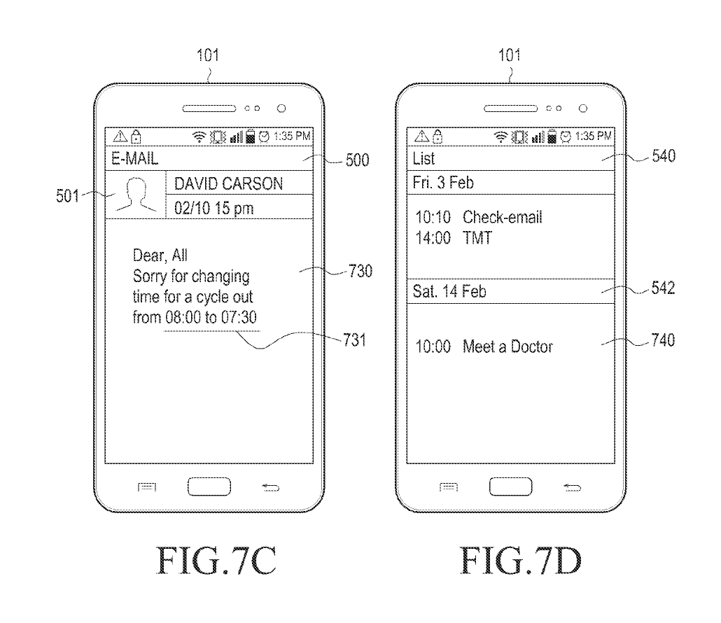

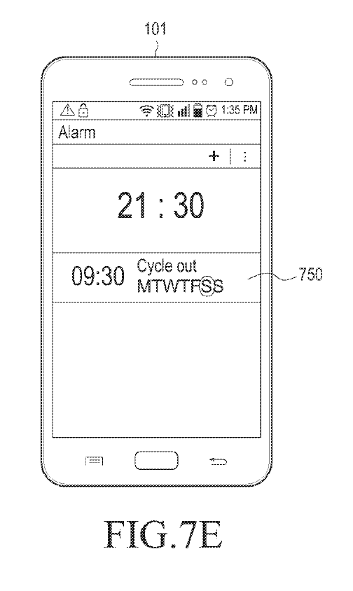

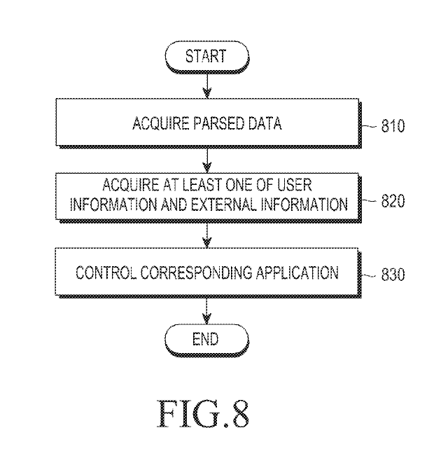

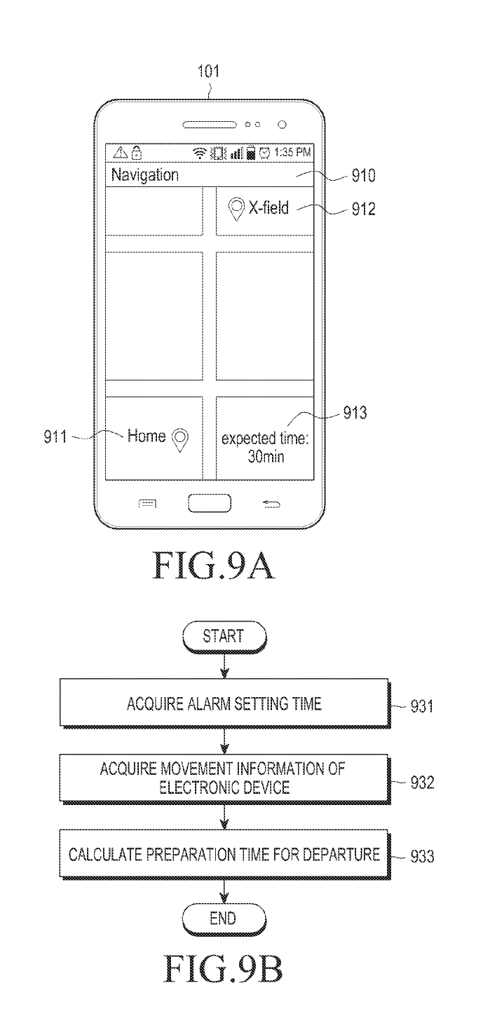

FIG. 8 is a flowchart of a method of managing a schedule according to an embodiment of the present disclosure. The embodiment of the present disclosure illustrated in FIG. 8 is described below in detail with reference to FIGS. 5A, 5B, 5C, 9A, 9B, and 9C.

The electronic device 101 may acquire parsed data in step 810. For example, as described above in detail with reference to FIGS. 5A, 5B, and 5C, the electronic device 101 may acquire parsed data including at least one of the schedule name 531, the scheduled time 532, and the scheduled place 533 through the email application 500. In step 820, the electronic device 101 may acquire at least one of user information and external information. The user information may be information related to a user of the electronic device 101. For example, the user information may indicate a preparation time spanning from an alarm time of the electronic device 101 to a time when the user moves, carrying the electronic device 101. The external information may be information related to an ambient environment of the electronic device 101. For example, the external information may be information about a time that it is expected to take to move from a first place to a second place at a certain time point, or with regard to certain traffic state information.

FIG. 9A illustrates external information according to an embodiment of the present disclosure.

Referring to FIG. 9A, to determine schedule information, the electronic device 101 may execute a navigation application 910. The navigation application 910 may request a path and an expected time from a location 911 of a user to an X-field 912 to a navigation service providing server. An execution screen of the navigation application 910 may include a map on which the location 911 of the user and the X-field 912 are displayed, and an expected time 913. The electronic device 101 may acquire the expected time 913 that is expected to be taken to reach the scheduled place 533 from the external information. In the process of determining schedule information, the electronic device 101 may acquire the expected time 913 as external information based on the scheduled place 533 which is parsed data. Particularly, the electronic device 101 may acquire the expected time 913 with respect to the scheduled time 532. In an embodiment of the present disclosure illustrated in FIG. 9A, it is assumed that the expected time 913 is 30 minutes. While the electronic device 101 is shown in FIG. 9A as displaying the execution screen of the navigation application 910, this is merely an example, and the present disclosure is not limited thereto. The electronic device 101 may acquire the expected time 913 without displaying the execution screen of the navigation application 910. In an embodiment of the present disclosure, the electronic device 101 may acquire the expected time 913 from many applications other than the navigation application, for example, a Web browsing application, which will be understood readily by those skilled in the art.

FIG. 9B is a flowchart of a method of acquiring user information according to an embodiment of the present disclosure.

Referring to FIG. 9B, the electronic device 101 may acquire an alarm setting time in step 931. The alarm setting time may be a time for which an alarm has been preset by the user.

In step 932, the electronic device 101 may acquire its movement information. According to an embodiment of the present disclosure, the electronic device 101 may acquire its movement information based on the coordinates of the electronic device 101 and time information at the coordinates. For example, the electronic device 101 may check a time point at which it has moved for a distance greater than or equal to a predetermined threshold.

In step 933, the electronic device 101 may calculate a preparation time for departure based on the acquired alarm setting time and the movement information. For example, the electronic device 101 may determine that the user-preset alarm setting time is 08:00 in step 931. Then, the electronic device 101 may determine that a time when the electronic device 101 moves for a distance greater than or equal to the threshold is 09:00 in step 932. Thus, the electronic device 101 may determine that the user leaves a home at the time. Accordingly, the electronic device 101 may calculate the preparation time for departure as user information to be the difference between 08:00 and 09:00, that is, one hour.

Referring to FIG. 8, the electronic device 101 may control a corresponding application based on the parsed data, and at least one of the user information and the external information in step 830. For example, as illustrated in FIG. 9C, the electronic device 101 may add a new alarm 940 in the alarm application 550 as a corresponding application. The electronic device 101 may set the new alarm 940 for 06:30, earlier than 08:00 by 1 hour 30 minutes, which is the sum of the expected time 913 and the preparation time for departure.

Those skilled in the art will readily understand that an embodiment of the present disclosure in which user information is a preparation time for departure and external information is a time expected to reach a destination is merely an example, and the present disclosure is not limited thereto. User information is any user information related to a use pattern of a user that can be acquired by the electronic device 101. Further, external information is any external information related to an ambient environment affecting a schedule that can be acquired by the electronic device 101.

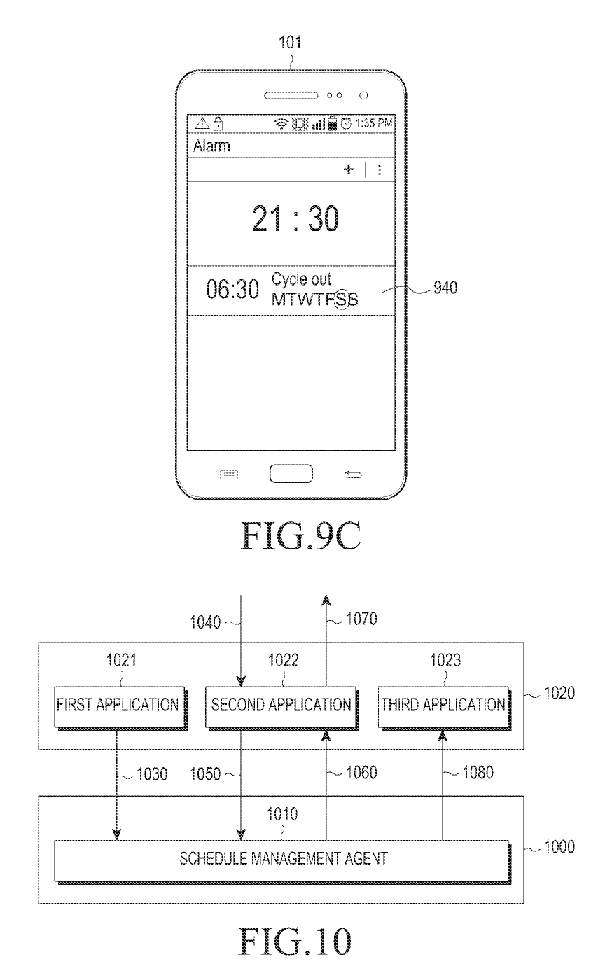

FIG. 10 is a block diagram of a schedule management system according to an embodiment of the present disclosure.

Referring to FIG. 10, the schedule management system may include a middleware layer 1000 and an application layer 1020. The application layer 1020 may be defined above the middleware layer 1000. The application layer 1020 may execute one or more applications (e.g., a first application 1021, a second application 1022, and a third application 1023) and perform data input/output between the applications (e.g., the first application 1021, the second application 1022, and the third application 1023) and the middleware layer 1000.

A schedule management agent 1010 may be defined at the middleware layer 1000. The schedule management agent 1010 may acquire schedule-related information, parse the schedule-related information, set schedule information, and output an application control command. According to an embodiment of the present disclosure, the schedule management agent 1010 may acquire schedule-related information 1030 from the first application 1021. For example, the first application 1021 may be a scheduling application.

The schedule management agent 1010 may acquire at least one of user information and external information 1050 from the second application 1022. For example, the second application 1022 may acquire the at least one of the user information and the external information 1050 based on externally acquired data 1040. Alternatively, the second application 1022 may acquire the at least one of the user information and the external information 1050 based on data stored in the electronic device 101. While the second application 1022 is shown in FIG. 10 as acquiring the externally acquired data 1040 without intervention of the middleware layer 1000, this operation is presented for ease of description. Thus, those skilled in the art will readily understand that the second application 1022 may acquire the externally acquired data 1040 from another agent (for example, an activity agent) defined at the middleware layer 1000.

The schedule management agent 1010 may set schedule information based on the parsed data of the acquired schedule-related information 1030 and the at least one of the user information and the external information 1050.

The schedule management agent 1010 may provide the set schedule information to the second application 1022 and the third application 1023. The second application 1022 and the third application 1023 may process the received set schedule information. The second application 1022 and the third application 1023 may output processing results. For example, the second application 1022 may output a processing result 1070 externally to the electronic device 101. While the second application 1022 is shown in FIG. 10 as outputting the processing result 1070 without intervention of the middleware layer 1000, this operation is presented for ease of description. Thus, those skilled in the art will readily understand that the second application 1022 may output the processing result 1070 to another agent (for example, the activity agent) defined at the middleware layer 1000 and the processing result 1070 is provided to a corresponding kernel and hardware.

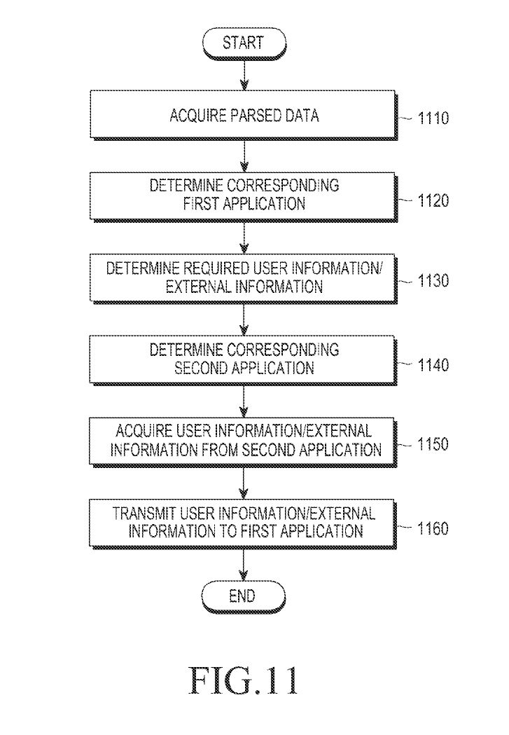

FIG. 11 is a flowchart of a method of managing a schedule according to an embodiment of the present disclosure.

Referring to FIG. 11, the electronic device 101 may acquire parsed data in step 1110. For example, the electronic device 101 may acquire at least one of a schedule name, a scheduled place, and a scheduled time as the parsed data.

In step 1120, the electronic device 101 may determine a first application corresponding to the parsed data. For example, the electronic device 101 may determine an alarm application to be the first application to which the parsed data will be applied. A mapping relationship between the parsed data and the first application may be pre-stored in the electronic device 101.

In step 1130, the electronic device 101 may determine at least one of required user information and external information. For example, the electronic device 101 may determine that the alarm application being the first application further requires an expected time and a preparation time for departure in addition to the schedule name, the scheduled place, and the scheduled time.

In step 1140, the electronic device 101 may determine a corresponding second application from which the at least one of the required user information and external information may be acquired. For example, the electronic device 101 may determine a navigation application in order to acquire an expected time and a preparation time for departure.

In step 1150, the electronic device 101 may acquire the user information and the external information by executing the second application. For example, the electronic device 101 may acquire the expected time and the preparation time for departure from the navigation application.

In step 1160, the electronic device 101 may transmit the acquired user information and external information to the first application. For example, the electronic device 101 may transmit information about the expected time and the preparation time for departure to the alarm application. The first application may set schedule information based on the received information about the expected time and the preparation time for departure, and the parsed data. For example, the electronic device 101 may set a new alarm based on the expected time, the preparation time for departure, the schedule name, the schedule place, and the scheduled time.

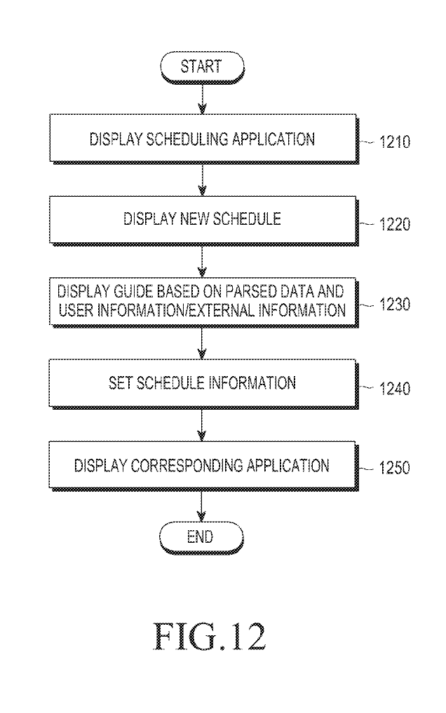

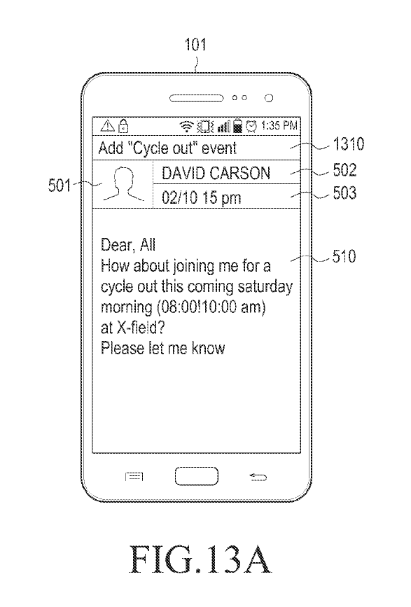

FIG. 12 is a flowchart of a method of configuring a screen in an electronic device according to an embodiment of the present disclosure. The embodiment of the present disclosure illustrated in FIG. 12 is described in detail with reference to FIGS. 13A and 13B.

Referring to FIG. 12, the electronic device 101 may display a scheduling application in step 1210. For example, the electronic device 101 may display an execution screen of the email application 500, as illustrated in FIG. 13A.

In step 1220, the electronic device 101 may display a new schedule. For example, the electronic device 101 may display the received contents 510.

In step 1230, the electronic device 101 may display guides 1310, 1320, 1330, and 1340 based on parsed data and at least one of user information and external information. The guide 1310 may include a message asking whether to generate schedule information for “cycle out.” As illustrated in FIG. 13B, the guide 1320 or 1330 may include identification information (e.g. List or Alarm) about a corresponding application, for example, a schedule management application, and schedule information. The guide 1340 may include a “Confirm” key with which to input a schedule information generation command. Upon selection of the guide 1310 in FIG. 13A, the electronic device 101 may display the guides 1320, 1330, and 1340. The electronic device 101 may perform parsing at a time when an email is initially viewed and display parsed data. If the email is viewed again or schedule information has not been set, the electronic device 101 may display the guide 1310 again. If the email is deleted, the electronic device 101 may ask a user whether to delete the configured schedule information and then may delete or preserve the schedule information.

In step 1240, the electronic device 101 may set schedule information in response to the selection of the guide 1340. The electronic device 101 may display an application corresponding to the set schedule information in step 1250. For example, the electronic device 101 may execute a schedule management application and an alarm application corresponding to the guides 1320 and 1330, respectively, and display the schedule management application and the alarm application.

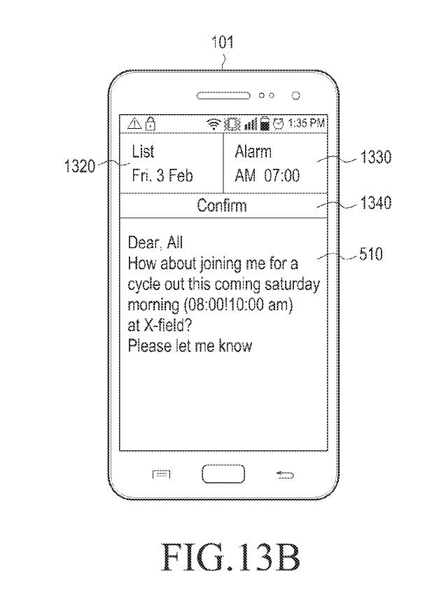

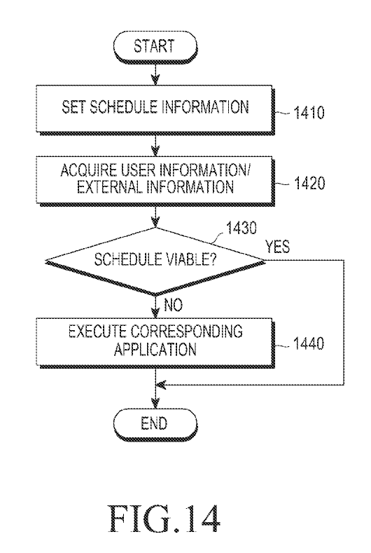

FIG. 14 is a flowchart of a method of managing a schedule according to an embodiment of the present disclosure. The embodiment of the present disclosure illustrated in FIG. 14 is described below in detail with reference to FIGS. 15A and 15B.

In step 1410, the electronic device 101 may set schedule information. For example, the electronic device 101 may set the schedule name “cycle out,” the scheduled time “10:00, 14 February,” and the scheduled place “X-field.”

In step 1420, the electronic device 101 may acquire at least one of user information and external information. Even after acquiring schedule information, the electronic device 101 may acquire at least one of user information and external information.

For example, the electronic device 101 may execute the navigation application 910, as illustrated in FIG. 15A. The electronic device 101 may acquire a time that it expected to be taken to move from a current location 1501 to the scheduled place 912. In the embodiment of the present disclosure illustrated in FIG. 15A, the electronic device 101 may determine the expected time to be 60 minutes. Further, the electronic device 101 may determine the current time to be 9:30.

In step 1430, the electronic device 101 may determine whether it is possible to fulfill the schedule based on the schedule information and at least one of the acquired user information and external information. For example, the electronic device 101 may determine that it is impossible to fulfill the “cycle out” schedule based on the scheduled time 10:00, the expected time 60 minutes, and the current time 9:30.

If the electronic device 101 determines that it is impossible to fulfill the schedule, the electronic device 101 may take a corresponding action by executing a corresponding application in step 1440. For example, the electronic device 101 may execute the email application 500, as illustrated in FIG. 15B. An execution screen of the email application 500 may include reception information 1511, a title 1512, and transmission contents 1513. The reception information 1511 may include information about an email sender that has acquired schedule-related information and a receiver. The title 1512 may include information to the effect that the schedule cannot be fulfilled. The transmission contents 1513 may also indicate that the schedule cannot be fulfilled.

While it has been described with regard to the embodiment of the present disclosure illustrated in FIGS. 15A and 15B that the electronic device 101 takes a corresponding action through a scheduling application, this is merely an example, and the present disclosure is not limited thereto. For example, the electronic device 101 may execute an alarm application as a schedule execution application, not a scheduling application, and indicate to the user that the schedule cannot be fulfilled.

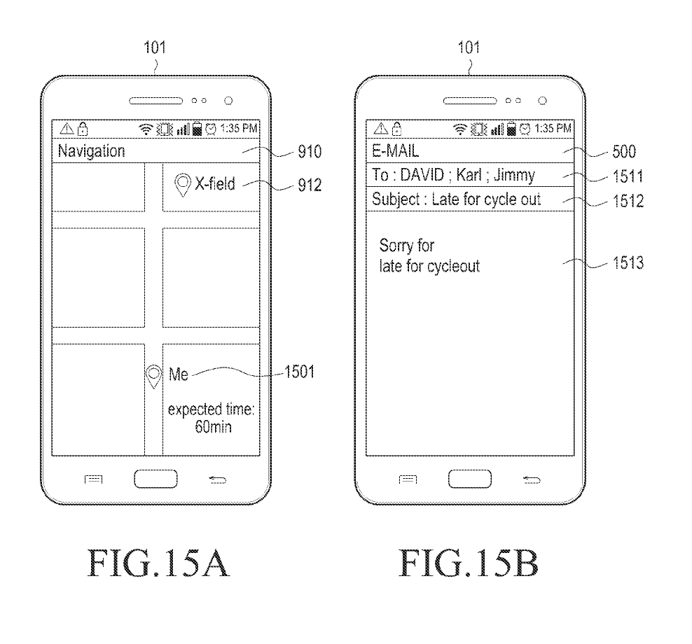

FIG. 16 is a flowchart of a method of managing a schedule according to an embodiment of the present disclosure.

Referring to FIG. 16, the electronic device 101 may set schedule information in step 1610. The electronic device 101 may set the schedule information by processing parsed data. Alternatively, the electronic device 101 may set the schedule information based on the parsed data and at least one of user information and external information.

In step 1620, the electronic device 101 may determine whether a schedule corresponding to the set schedule information overlaps with another existing set schedule.

If the schedule overlaps with another schedule, the electronic device 101 may receive and check a new schedule in step 1630. The new schedule may be generated by adjusting the scheduled time of the set schedule. The electronic device 101 may adjust the scheduled time of the set schedule to not overlap with another schedule and provide the adjusted scheduled time.

According to an embodiment of the present disclosure, if a schedule that has been set is changed as described above, the electronic device 101 may output adjustment information by a scheduling application. For example, the electronic device 101 may control an email application by which schedule-related information has been received to transmit the schedule adjustment information to another electronic device.

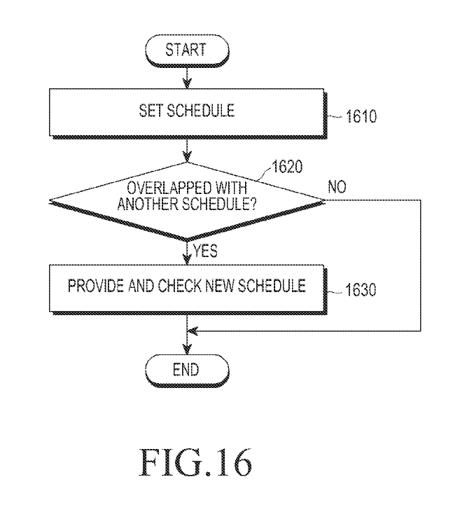

FIG. 17 is a flow diagram of an operation for interacting with a vehicle control device according to an embodiment of the present disclosure.

Referring to FIG. 17, the electronic device 101 may share schedule information with another electronic device, for example, a vehicle control device 102. For example, the electronic device 101 may share the schedule information with the vehicle control device 102 by Bluetooth communication.

The electronic device 101 may receive an advertisement signal or message from the vehicle control device 102 in step 1701. In step 1703, the electronic device 101 may request a pairing setup with the vehicle control device 102. The electronic device 101 may receive a pairing response from the vehicle control device 102 in step 1705 and may be paired with the vehicle control device 102 in step 1707. While it has been described that the electronic device 101 receives an advertisement signal and requests a pairing setup in steps 1701 to 1705, this is merely an example, and the present disclosure is not limited thereto. Those skilled in the art will readily understand that the vehicle control device 102 may receive an advertisement signal from the electronic device 101 and request a pairing setup with the electronic device 101.

The electronic device 101 may transmit place information to the vehicle control device 102 in step 1709. In step 1711, the vehicle control device 102 may execute a navigation application, process received place information and time information, and output a processing result.

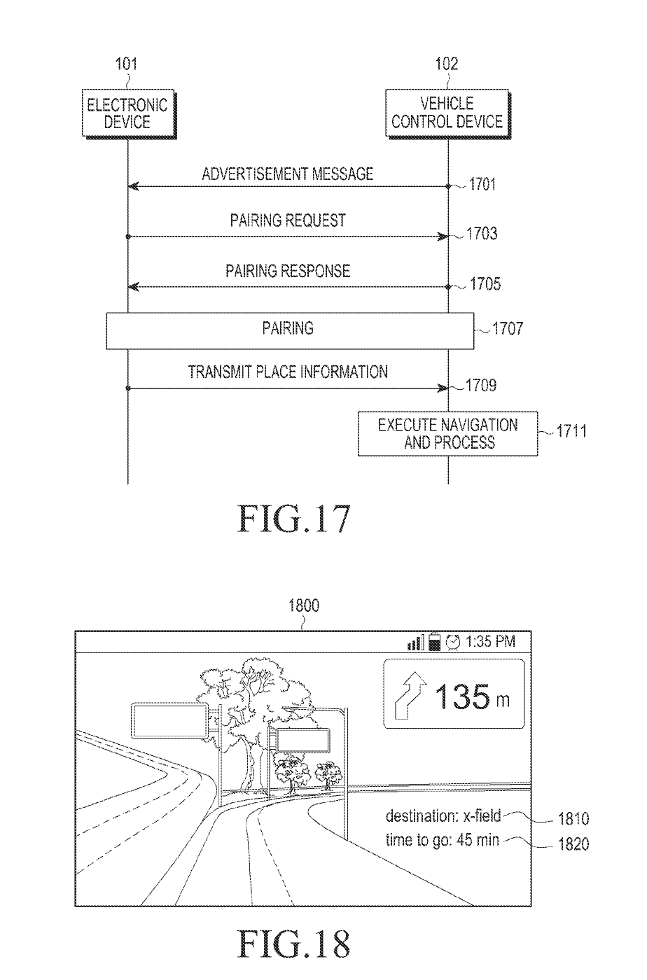

FIG. 18 illustrates an execution screen 1800 of a navigation application in the vehicle control device 102 according to an embodiment of the present disclosure.

Referring to FIG. 18, the execution screen 1800 of the navigation application may include a destination 1810 and an expected time 1820 along with a map of the neighborhood. The navigation application may display the destination 1810 based on received place information. In an embodiment of the present disclosure, the electronic device 101 may further transmit time information among schedule information to the vehicle control device 102. The navigation application may display the received time information together with the expected time 1820 and may indicate whether the destination can be reached within a certain time.

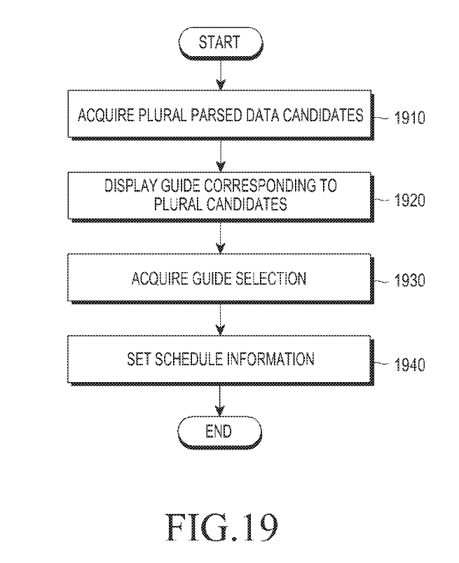

FIG. 19 is a flowchart of a method for managing a schedule according to an embodiment of the present disclosure.

Referring to FIG. 19, the electronic device 101 may acquire a plurality of parsed data candidates in step 1910. For example, the electronic device 101 may acquire schedule-related information from an email application. Herein, it is assumed that a received email includes a plurality of time points. For example, the email includes 10:00, 11:30, and 15:20 as the time points. The electronic device 101 may acquire three parsed data candidates 10:00, 11:30, and 15:30 by parsing information about the scheduled time points.

In step 1920, the electronic device may display a guide corresponding to the plurality of parsed data candidates. The guide may include the plurality of parsed data candidates.

In step 1930, the electronic device 101 may acquire a selection of at least one of the plurality of parsed data candidates. The electronic device 101 may set schedule information based on parsed data corresponding to the acquired selection in step 1940.

According to an embodiment of the present disclosure, an electronic device may include a processor configured to acquire schedule-related information, acquire parsed data by parsing the acquired schedule-related information, and provide the parsed data to a plurality of applications, and an output unit configured to output a result of processing the parsed data through the plurality of applications.

According to an embodiment of the present disclosure, the processor may determine a property of the parsed data and determine the plurality of applications based on the determined property of the parsed data.

According to an embodiment of the present disclosure, the processor may acquire a schedule information change caused by a first application and apply the schedule information change to each of the plurality of applications, and the output unit may output a result of applying the schedule information change.

According to an embodiment of the present disclosure, the processor may control the display of a guide including the parsed data and may provide the parsed data to the plurality of applications based on a schedule information generation command acquired through the guide.

According to an embodiment of the present disclosure, the processor may determine whether schedule information corresponding to the parsed data overlaps with other pre-stored schedule information. If the schedule information corresponding to the parsed data overlaps with other pre-stored schedule information, the processor may control display of a guide that recommends a new schedule.

According to an embodiment of the present disclosure, a method of managing a schedule may include acquiring schedule-related information, acquiring parsed data by parsing the acquired schedule-related information, providing the parsed data to a plurality of applications, and processing the parsed data through the plurality of applications.

According to an embodiment of the present disclosure, the method may further include determining a property of the parsed data and determining the plurality of applications based on the determined property of the parsed data.

According to an embodiment of the present disclosure, the method may further include acquiring a schedule information change caused by a first application and applying the schedule information change to each of the plurality of applications.

According to an embodiment of the present disclosure, the method may further include displaying a guide including the parsed data, and providing the parsed data to the plurality of applications based on a schedule information generation command acquired through the guide.

According to an embodiment of the present disclosure, the method may further include determining whether schedule information corresponding to the parsed data overlaps with other pre-stored schedule information, and if the schedule information corresponding to the parsed data overlaps with other pre-stored schedule information, displaying a guide that recommends a new schedule.

According to an embodiment of the present disclosure, an electronic device may include a processor configured to acquire parsed data by parsing schedule-related information, acquire at least one of user information about the electronic device and external information, and acquire schedule information based on the parsed data and the at least one of the user information and the external information, and an output unit configured to output the schedule information.

According to an embodiment of the present disclosure, the processor may determine a property of the schedule information and determine a corresponding application based on the determined property of the schedule information.

According to an embodiment of the present disclosure, the processor may acquire a modification of the schedule information corresponding to the parsed data based on the at least one of the user information and the external information.

According to an embodiment of the present disclosure, the parsed data may include at least one of a scheduled time, a scheduled place, and a schedule name, the user information may include information related to a use pattern of the electronic device, and the external information may include at least one of traffic state information related to at least one of the scheduled time and the scheduled place, and expected time information.

According to an embodiment of the present disclosure, the processor may determine whether the schedule information is viable based on the at least one of the user information and the external information and, if the schedule information is not viable, may control the output unit to output a corresponding action.

According to an embodiment of the present disclosure, the output unit may display a guide including the schedule information, and the processor may generate the schedule information based on a schedule information generation command acquired through the guide.

According to an embodiment of the present disclosure, the processor may determine whether the schedule information overlaps with other pre-stored schedule information, and if the schedule information overlaps with other pre-stored schedule information, controls the output unit to display a guide recommending a new schedule.

According to an embodiment of the present disclosure, a method of managing a schedule may include acquiring parsed data by parsing schedule-related information, acquiring at least one of user information about the electronic device and external information, acquiring schedule information based on the parsed data and the at least one of the user information and the external information, and outputting the schedule information.

According to an embodiment of the present disclosure, the acquisition of schedule information may include acquiring a modification of the schedule information corresponding to the parsed data based on the at least one of the user information and the external information.

According to an embodiment of the present disclosure, in a non-transitory computer-readable storage medium storing a method for managing a schedule, the method may include acquiring parsed data by parsing schedule-related information, acquiring at least one of user information about the electronic device and external information, acquiring schedule information based on the parsed data and the at least one of the user information and the external information, and outputting the schedule information.

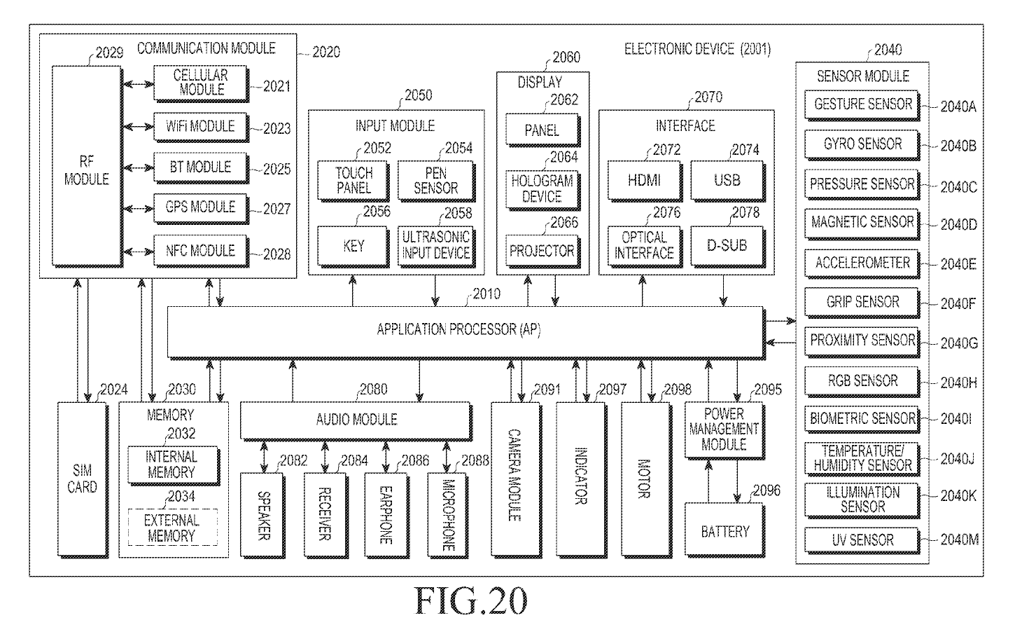

FIG. 20 is a block diagram of an electronic device 2001 according to an embodiment of the present disclosure. The electronic device 2001 may include, for example, all or part of the electronic device 101 illustrated in FIG. 1. For example, the electronic device 101 illustrated in FIG. 1 may include all or part of the electronic device 2001 illustrated in FIG. 20.

Referring to FIG. 20, the electronic device 2001 may include at least one Application Processor (AP) 2010, a communication module 2020, a Subscriber Identification Module (SIM) card 2024, a memory 2030, a sensor module 2040, an input module 2050, a display 2060, an interface 2070, an audio module 2080, a camera module 2091, a power management module 2095, a battery 2096, an indicator 2097, and a motor 2098.

The AP 2010 may, for example, control one or more hardware or software components that are connected to the AP 2010 by executing an OS or an application program and may perform processing or computation of various types of data. The AP 2010 may be implemented, for example, as a System on Chip (SoC). According to an embodiment of the present disclosure, the AP 2010 may further include a Graphics Processing Unit (GPU) and/or an image signal processor. The AP 2010 may include at least a part (for example, a cellular module 2021) of the components illustrated in FIG. 20. The AP 2010 may load a command or data received from at least one other component (for example, a non-volatile memory), process the loaded command or data, and store various types of data in the non-volatile memory.

The communication module 2020 may have the same configuration as, or a similar configuration to, the communication interface 170 illustrated in FIG. 1. The communication module 2020 may include the cellular module 2021, a WiFi module 2023, a BT module 2025, a GPS module 2027, a Near Field Communication (NFC) module 2028, and a Radio Frequency (RF) module 2029.

The cellular module 2021 may provide services such as voice call, video call, Short Message Service (SMS), or Internet access through a communication network. According to an embodiment of the present disclosure, the cellular module 2021 may identify and authenticate the electronic device 2001 within a communication network, using the SIM card 2024. According to an embodiment of the present disclosure, the cellular module 2021 may perform at least a part of the functions of the AP 2010. According to an embodiment of the present disclosure, the cellular module 2021 may include a Communication Processor (CP).

Each of the WiFi module 2023, the BT module 2025, the GPS module 2027, and the NFC module 2028 may include, for example, a processor that may process data received or transmitted by the respective modules. According to an embodiment of the present disclosure, at least a part (for example, two or more) of the cellular module 2021, the WiFi module 2023, the BT module 2025, the GPS module 2027, or the NFC module 2028 may be included in an Integrated Circuit (IC) or an IC package.

The RF module 2029 may transmit and receive communication signals (for example, RF signals). The RF module 2029 may include, for example, a transceiver, a Power Amplifier Module (PAM), a frequency filter, a Low Noise Amplifier (LNA), an antenna, or the like. According to another embodiment of the present disclosure, at least one of the cellular module 2021, the WiFi module 2023, the BT module 2025, the GPS module 2027, or the NFC module 2028 may transmit and receive RF signals via a separate RF module.

The SIM card 2024 may include, for example, an embedded SIM. The SIM card 2024 may include a unique identifier (for example, an Integrated Circuit Card IDentifier (ICCID)) or subscriber information (for example, an International Mobile Subscriber Identity (IMSI)).

The memory 2030 (for example, the memory 130 in FIG. 1) may include, for example, an internal memory 2032 or an external memory 2034. The internal memory 2032 may be at least one of, for example, a volatile memory (for example, a Dynamic Random Access Memory (DRAM), a Static RAM (SRAM), or a Synchronous DRAM (SDRAM)), a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, or a NOR flash memory), a hard drive, or a Solid State Drive (SSD).

The external memory 2034 may further include, for example, a flash drive such as a Compact Flash (CF) drive, a Secure Digital (SD) memory card, a micro Secure Digital (micro-SD) memory card, a mini Secure Digital (mini-SD) memory card, an extreme Digital (xD) memory card, or a memory stick. The external memory 2034 may be operatively and/or physically coupled to the electronic device 2001 via various interfaces.

The sensor module 2040 may, for example, measure physical quantities or detect operational states associated with the electronic device 2001, and convert the measured or detected information into electrical signals. The sensor module 2040 may include at least one of, for example, a gesture sensor 2040A, a gyro sensor 2040B, an atmospheric pressure sensor 2040C, a magnetic sensor 2040D, an accelerometer 2040E, a grip sensor 2040F, a proximity sensor 2040G a color sensor (for example, a Red, Green, Blue (RGB) sensor) 2040H, a biometric sensor 20401, a temperature/humidity sensor 2040J, an illumination sensor 2040K, or an Ultra Violet (UV) light sensor 2040M. Additionally or alternatively, the sensor module 2040 may include, for example, an Electrical-nose (E-nose) sensor, an ElectroMyoGraphy (EMG) sensor, an EEG ElectroEncephaloGram (EEG) sensor, an ElectroCardioGram (ECG) sensor, an InfraRed (IR) sensor, an iris sensor, and/or a finger print sensor. The sensor module 2040 may further include a control circuit for controlling one or more sensors included therein. According to an embodiment of the present disclosure, the electronic device 2001 may further include a processor configured to control the sensor module 2040, as a part of, or separately from, the AP 2010. Thus, while the AP 2010 is in a sleep state, the control circuit may control the sensor module 2040.

The input device 2050 may include a touch panel 2052, a (digital) pen sensor 2054, a key 2056, or an ultrasonic input device 2058. The touch panel 2052 may operate in at least one of, for example, capacitive, resistive, infrared, and ultrasonic methods. The touch panel 2052 may further include a control circuit. The touch panel 2052 may further include a tactile layer to thereby provide haptic feedback to the user.

The (digital) pen sensor 2054 may include, for example, a detection sheet which is a part of the touch panel or separately configured from the touch panel. The key 2056 may include, for example, a physical button, an optical key, or a keypad. The ultrasonic input device 2058 may be a device configured to identify data by detecting, using a microphone (for example, a microphone 2088), ultrasonic signals generated by an input device capable of generating an ultrasonic signal.

The display 2060 (for example, the display 160 in FIG. 1) may include a panel 2062, a hologram device 2064, or a projector 2066. The panel 2062 may have the same configuration as, or a similar to, that of the display 160 of FIG. 1. The panel 2062 may be configured to be, for example, flexible, transparent, or wearable. The panel 2062 and the touch panel 2052 may be implemented as a single module. The hologram device 2064 may utilize the interference of light to provide a three-dimensional image in empty space. The projector 2066 may provide an image by projecting light onto a screen. The screen may be positioned, for example, internally or externally to the electronic device 2001. According to an embodiment of the present disclosure, the display 2060 may further include a control circuit for controlling the panel 2062, the hologram device 2064, or the projector 2066.

The interface 2070 may include, for example, a High-Definition Multimedia Interface (HDMI) 2072, a USB 2074, an optical interface 2076, or a D-subminiature (D-sub) connector 2078. The interface 2070 may be included, for example, in the communication interface 170 of FIG. 1. Additionally or alternatively, the interface 2070 may include, for example, a Mobile High-definition Link (MHL) interface, an SD/MultiMedia Card interface, or an Infrared Data Association (IrDA) interface.

The audio module 2080 may encode/decode a voice into an electrical signal, and vice versa. At least a part of the components of the audio module 2080 may be included, for example, in the I/O interface 140 illustrated in FIG. 1. The audio module 2080 may process audio information input into, or output from, for example, a speaker 2082, a receiver 2084, an earphone 2086, or the microphone 2088.

The camera module 2091 may capture, for example, still images or a video. According to an embodiment of the present disclosure, the camera module 2091 may include one or more image sensors (for example, a front sensor or a rear sensor), a lens, an Image Signal Processor (ISP), or a flash (for example, a Light Emitting Diode (LED) or a Xenon lamp).

The power management module 2095 may manage power of the electronic device 2001. According to an embodiment of the present disclosure, the power management module 2095 may include a Power Management Integrated Circuit (PMIC), a charger IC, or a battery gauge. The PMIC may adopt wired and/or wireless charging. The wireless charging may be performed, for example, in a magnetic resonance scheme, a magnetic induction scheme, or an electromagnetic wave scheme, and may use additional circuits for wireless charging, such as a coil loop, a resonance circuit, or a rectifier. The battery gauge may measure, for example, a charge level, a voltage while charging, current, or temperature of the battery 2096. The battery 2096 may include, for example, a rechargeable battery and/or a solar battery.

The indicator 2097 may indicate one or more states (for example, a boot status, a message status, or a charge status) of the electronic device 2001 or a part of the electronic device 2001 (for example, the AP 2010). The motor 2098 may convert an electrical signal into a mechanical vibration and generate vibrations or a haptic effect. The electronic device 2001 may include a device for supporting mobile TV (for example, a GPU). The device for supporting mobile TV may process media data compliant with, for example, a Digital Multimedia Broadcasting (DMB) standard, a Digital Video Broadcasting (DVB) standard, or a MediaFLO standard.

As is apparent from the foregoing description of various embodiments of the present disclosure, an electronic device and a method for managing a schedule can be provided, which sets schedule information after parsing, upon receipt of schedule-related information. The electronic device can control a plurality of applications using the set schedule information. Further, the electronic device can manage a schedule based on at least one of user information and external information as well as received schedule-related information.

Each of the components of the electronic device described above according to the present disclosure may include one or more components, and each component's name may vary according to the type of the electronic device. The electronic device according to an embodiment of the present disclosure may include at least one of the above-described components, and some components may be omitted or additional components may be included. Also, some of the components of the electronic device according to an embodiment of the present disclosure may be combined into a single entity and may perform functions identical to those of the respective components before their combination.

The terms “module” and “function” as used herein may include their ordinary meanings including, for example, a unit of one, or a combination of two or more. The term “module” or “function” may be used interchangeably with terms such as, for example, “unit,” “logic,” “logical block,” “component” or “circuit.” The terms “module” and “function” may refer to the smallest unit for performing one or more functions, or a portion thereof. The terms “module” and “function” may refer to an entity that may be implemented mechanically, or electronically. For example, the terms “module” and “function” may include at least one of a known, or to-be-developed, an Application-Specific Integrated Circuit (ASIC), a Field-Programmable Gate Array (FPGA) and a programmable logic device that perform certain operations.

At least a part of devices (for example, modules and their functions) or methods according to an embodiment of the present disclosure may be implemented as commands stored in a non-transitory computer-readable storage medium, in the form of a programming module. When the commands are executed by a processor (for example, the processor 120 in FIG. 1), one or more processors may execute functions corresponding to the commands. The non-transitory computer-readable storage medium may be, for example, the memory 130 in FIG. 1.

The non-transitory computer-readable medium may include a hard disk, a floppy disk, tape, magnetic media (for example, magnetic tape), optical media (for example, a Compact Disc Read-Only Memory (CD-ROM)), a Digital Versatile Disc (DVD), magneto-optical media (for example, a floptical disk), hardware devices (for example, a ROM, a RAM or a flash memory)), and the like. Program instructions may include machine level code that is generated by a compiler or high-level code that may be executed by a computer using an interpreter. The functions of hardware discussed above may be implemented as one or more software modules, and vice versa in order to perform an operation according to an embodiment of the present disclosure.

A module or a programming module according to an embodiment of the present disclosure may include one or more of the above-described components, may omit a portion thereof, or may include additional components. Operations that are performed by a module, a programming module or other components according to the present disclosure may be processed in a serial, parallel, repetitive or heuristic manner, and some operations may be omitted or additional operations may be added.

According to an embodiment of the present disclosure, a storage medium storing commands is provided. The commands are configured to allow at least one processor to perform at least one operation, when the commands are executed by the at least one processor. The at least one operation may include acquiring parsed data by parsing schedule-related information, providing the parsed data to a plurality of applications, and processing the parsed data through the plurality of applications.

While the present disclosure has been shown and described with reference to certain embodiments thereof, it will be understood by those skilled in the art that various changes in form and details may be made therein without departing from the scope and spirit of the disclosure as defined by the appended claims and their equivalents.

What is claimed is:

1. An electronic device, comprising:
a processor configured to acquire schedule-related information, acquire parsed data by parsing the acquired schedule-related information, and transmit the parsed data to a plurality of applications; and
an output unit configured to output a result of processing the parsed data through the plurality of applications.

2. The electronic device of claim 1, wherein the processor is further configured to determine a property of the parsed data, and determine the plurality of applications based on the determined property.

3. The electronic device of claim 1, wherein the processor is further configured to acquire a schedule information change caused by a first application, and apply the schedule information change to each of the plurality of applications, wherein the output unit outputs a result of applying the schedule information change.

4. The electronic device of claim 1, wherein the processor is further configured to control a display of a guide including the acquired parsed data, and transmit the parsed data to the plurality of applications based on a schedule information generation command acquired through the guide.

5. The electronic device of claim 1, wherein the processor is further configured to determine whether schedule information corresponding to the parsed data overlaps with other pre-stored schedule information, and if the schedule information corresponding to the parsed data overlaps with the other pre-stored schedule information, control a display of a guide recommending a schedule different from the pre-stored schedule information.

6. A method of managing a schedule, the method comprising:
acquiring schedule-related information;
acquiring parsed data by parsing the acquired schedule-related information;
transmitting the parsed data to a plurality of applications; and
processing the parsed data through the plurality of applications.

7. The method of claim 6, further comprising:
determining a property of the parsed data; and
determining the plurality of applications based on the determined property.

8. The method of claim 6, further comprising:
acquiring a schedule information change caused by a first application; and
applying the schedule information change to each of the plurality of applications.

9. The method of claim 6, further comprising:
displaying a guide including the acquired parsed data; and
transmitting the parsed data to the plurality of applications based on a schedule information generation command acquired through the guide.

10. The method of claim 6, further comprising:
determining whether schedule information corresponding to the parsed data overlaps with other pre-stored schedule information; and
if the schedule information corresponding to the parsed data overlaps with other pre-stored schedule information, displaying a guide recommending a schedule that is different from the other pre-stored schedule information.

11. An electronic device, comprising:
a processor configured to acquire parsed data by parsing schedule-related information, acquire at least one of user information about the electronic device and external information, and acquire schedule information based on the parsed data and the at least one of the user information about the electronic device and the external information; and
an output unit configured to output the schedule information.

12. The electronic device of claim 11, wherein the processor is further configured to determine a property of the schedule information, and determine a corresponding application based on the determined property.

13. The electronic device of claim 11, wherein the processor is further configured to acquire the schedule information modified from schedule information corresponding to the parsed data based on the at least one of the user information and the external information.

14. The electronic device of claim 11, wherein the parsed data includes at least one of a scheduled time, a scheduled place, and a schedule name, wherein the user information includes information related to a use pattern of the electronic device, and wherein the external information includes at least one of traffic state information related to at least one of the scheduled time and the scheduled place, and expected time information.

15. The electronic device of claim 11, wherein the processor is further configured to determine whether the schedule information is viable based on the at least one of the user information and the external information and, if the schedule information is not viable, control the output unit to output a corresponding action.

16. The electronic device of claim 11, wherein the output unit is further configured to display a guide including the schedule information, and the processor is further configured to generate the schedule information based on a schedule information generation command acquired through the guide.

17. The electronic device of claim 16, wherein the processor is further configured to determine whether the schedule information overlaps with other pre-stored schedule information, and if the schedule information overlaps with other pre-stored schedule information, control the output unit to display a guide recommending a schedule different from the other pre-stored schedule information.

18. A method of managing a schedule in an electronic device, the method comprising:
acquiring schedule-related information;
acquiring parsed data by parsing the schedule-related information;
acquiring at least one of user information about the electronic device and external information;
acquiring schedule information based on the parsed data and the at least one of the user information and the external information; and
outputting the schedule information.

19. The method of claim 18, wherein the acquisition of schedule information comprises acquiring the schedule information modified from schedule information corresponding to the parsed data based on the at least one of the user information and the external information.

20. A non-transitory computer-readable storage medium recording a program for performing a method of managing a schedule in an electronic device, the method comprising:
acquiring schedule-related information;
acquiring parsed data by parsing the schedule-related information;
acquiring at least one of user information about the electronic device and external information;
acquiring schedule information based on the parsed data and the at least one of the user information and the external information; and
outputting the schedule information.
